(19) United States
(12) Patent Application Publication
(10) Pub. No.: US 2006/0267518 A1
(43) Pub. Date: Nov. 30, 2006

(54) Electron emission display device and method of controlling brightness thereof

(76) Inventor: Duck Gu Cho, Changnyeong-gun (KR)

Correspondence Address: CHRISTIE, PARKER & HALE, LLP, PO BOX 7068, PASADENA, CA, 91109-7068, US

(21) Appl. No.: 11/408,818

(22) Filed: Apr. 20, 2006

(30) Foreign Application Priority Data
May 26, 2005 (KR) 2005-44698

(51) Int. Cl. H05B 41/36

(52) U.S. Cl. 315/291

(57) ABSTRACT

Disclosed are an electron emission display device and a method of controlling the brightness thereof. The electron emission display device includes a controller for summing input image data signals to obtain image levels, a power source supply unit for receiving the image levels to control anode voltage levels to correspond to the image levels and to output the anode voltage levels, and a display region for realizing image brightness in accordance with the anode voltage levels supplied by the power source supply unit. As such, the image data are added to each other, and the anode voltages corresponding to the image data are controlled to realize peak brightness.

### CROSS-REFERENCE TO RELATED APPLICATION

This application claims priority to and the benefit of Korean Patent Application No. 10-2005-0044698, filed on May 26, 2005, in the Korean Intellectual Property Office, the entire content of which is incorporated herein by reference.

### BACKGROUND

1. Field of the Invention

The present invention relates to an electron emission display device and a method of controlling the brightness thereof, and more particularly to an electron emission display device capable of summing image data to control anode voltages corresponding to the image data and to thus realize peak brightness and a method of controlling the brightness thereof.

2. Discussion of Related Art

In general, in a flat panel display (FPD) device, side walls are provided between two substrates to fabricate an airtight chamber (or container) and suitable materials are arranged in the chamber so that a desired screen is displayed. The FPD device has become more important with the increase in the development of multimedia. Various FPD devices, such as liquid crystal display (LCD) devices, plasma display panel (PDP) devices, and electron emission display devices have been developed and put into practical uses.

In particular, in an electron emission display device, light is emitted from a fluorescent body through impact with electron beams like in a cathode ray tube (CRT). As such, the electron emission display device has the desirable characteristics of the CRT while still being a FPD of low power consumption without the distortion of images. Also, the electron emission display device has been spotlighted as a satisfactory next generation display device due to its wide viewing angle, high response speed, high brightness, high resolution, and thinness.

In general, electron emission devices of an electron emission display device can be classified into electron emission devices in which hot cathodes are used as electron sources and electron emission devices in which cold cathodes are used as electron sources. The electron emission display devices in which the cold cathodes are used as the electron emission devices include field emitter array (FEA) type electron emission display devices, surface conduction emitter (SCE) type electron emission display devices, metal-insulator-metal (MIM) and metal-insulator-semiconductor (MIS) type electron emission display devices, and ballistic electron surface emitter (BSE) type electron emission display devices.

An electron emission display device has a triode structure that includes cathode, anode, and gate electrodes. In particular, cathode electrodes commonly used as scan electrodes are formed on a substrate and insulating layers having holes and gate electrodes commonly used as data electrodes are stacked on the cathode electrodes. Emitters that are electron emission sources are formed in the holes to contact the cathode electrodes.

According to the electron emission display device having the above structure, a high electric field is concentrated on the emitters so that electrons are emitted through a quantum mechanic tunneling effect and that the electrons emitted from the emitters are accelerated by the voltages applied between the cathode electrodes and the anode electrodes to collide with RGB fluorescent layers formed in the anode electrodes and to thus emit light from the bodies of the fluorescent layers. As a result, images are displayed.

The brightness of images displayed by the emitted electrons colliding with the fluorescent layers varies with the values of input digital image signals. In particular, the values of the digital image signals are eight-bit RGB data. That is, the values of the digital image signals are 0(00000000₍₂₎) to 255(11111111₍₂₎) and 256 gray scales may be represented by the 256 values, and the brightness of color is determined by the digital values.

A pulse width modulation (PWM) method or a pulse amplitude modulation (PAM) method can be used to control the brightness determined by the values of the digital image signals.

According to the PWM method, the pulse widths of the driving waveforms applied to the data electrodes are modulated in accordance with the digital image signals input from a data electrode driver. When “255” is input as the value of the digital image signal within a maximum on-time, the pulse width is at its maximum width so that maximum brightness is displayed. When “127” is input as the value of the digital image signal, the pulse width is reduced to ½ so that brightness is controlled to be less than the maximum brightness.

On the other hand, according to the PAM method, the pulse widths are uniform regardless of the input digital image signals, however, the pulse voltage levels, that is, the magnitudes of the pulses of the driving waveforms applied to the data electrodes, vary with the input digital image signals so that brightness is controlled.

On the other hand, according to the conventional electron emission display device, the voltages between the gate electrodes and the cathode electrodes are controlled when the images have the peak brightness.

However, in order to display smooth images, the image level signal widths (e.g., pulse widths) must be very small. Therefore, there are limitations on controlling the image levels so that white emission may occur.

### SUMMARY OF THE INVENTION

Accordingly, it is an aspect of the present invention to provide an electron emission display device capable of summing image data to control the anode voltages corresponding to the image data and to thus realize peak brightness and a method of controlling the brightness thereof.

In order to achieve the foregoing and/or other features of the present invention, according to a first embodiment of the present invention, there is provided an electron emission display device including a controller for summing input image data signals to obtain one or more image levels, a power source supply unit for receiving the image levels to control one or more anode voltage levels to correspond to the image levels and to output the anode voltage levels, and a display region for realizing image brightness in accordance with the anode voltage levels supplied by the power source supply unit.

In one embodiment, the controller includes a frame memory for storing input image data, an operating unit for summing the image data stored in the frame memory in units of frames to compare the summed image data with a predetermined value to determine the image levels, and a look-up table for storing the average value of reference brightness levels in accordance with the image levels of the operating unit. The power source supply unit includes a microcomputer for receiving the image levels controlled by the controller to output reference voltage levels corresponding to the image levels and a DC/DC converter for converting widths of the reference voltage levels of the microcomputer to output signal widths (e.g., pulse widths).

Also, there is provided a method of controlling the brightness of an electron emission display device, the method including summing received image data per frame, determining one or more image levels by the sum of the image data to output the image levels, and comparing the image levels with a predetermined value to control one or more anode voltages and to apply the anode voltages.

As such, according to embodiments of the present invention, image data are added to each other to control anode voltages corresponding to the image data and to thus realize peak brightness.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 schematically illustrates the structure of an electron emission display device in an exemplary embodiment according to the present invention;

FIG. 2 illustrates an example of a part of a display region that can be used for the electron emission display device of FIG. 1;

FIG. 3 illustrates an example of a controller that can be used for the electron emission display device of FIG. 1;

FIG. 4 schematically illustrates a structure of a power source supply unit of FIG. 1;

FIG. 5 is a flowchart of a method of controlling brightness of an electron emission display device in an exemplary embodiment according to the present invention; and

FIG. 6 schematically illustrates anode voltage levels in accordance with image levels in an exemplary embodiment according to the present invention.

### DETAILED DESCRIPTION

Hereinafter, an electron emission display device in an exemplary embodiment according to the present invention will be described with reference to the attached drawings. There may be parts shown in the drawings, or parts not shown in the drawings, that are not discussed in the specification as they are not essential to a complete understanding of the invention. Like reference numerals designate like elements throughout the specification. In addition, when a first element is on a second element, the first element may not only be directly on the second element but may also be indirectly on the second element via a third element

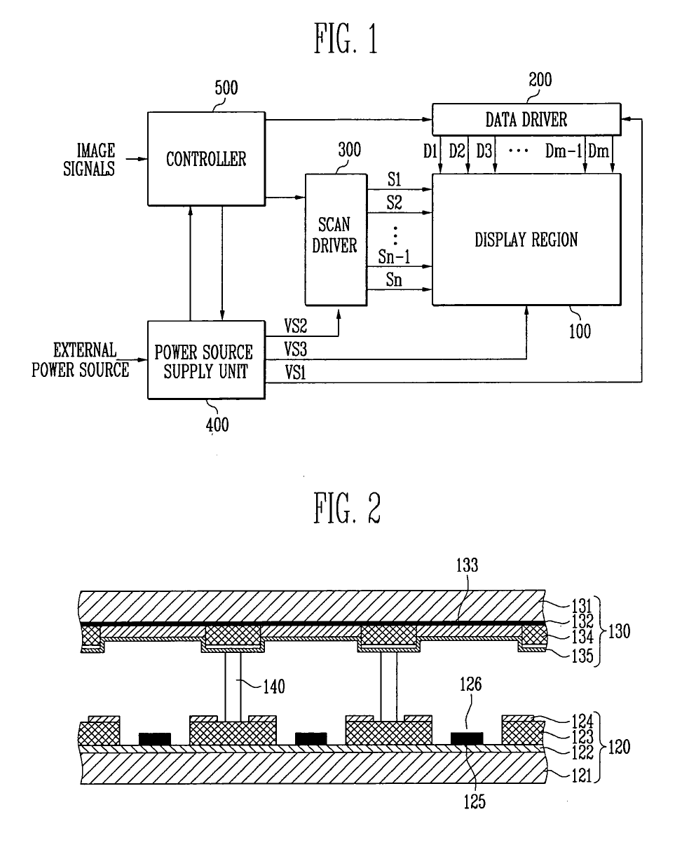

FIG. 1 schematically illustrates the structure of an electron emission display device in an exemplary embodiment according to the present invention. Referring to FIG. 1, the electron emission display device includes a display region (having a plurality of pixel units) 100, a data driver 200, a scan driver 300, a power source supply unit 400, and a controller 500.

The display region 100 includes n scan lines S1, S2, . . . , and Sn, m data lines D1, D2, . . . , and Dm, and anode electrodes ANODE. The scan lines S1, S2, . . . , and Sn and the data lines D1, D2, . . . , and Dm are formed to cross (or cross over) each other. The anode electrodes ANODE may be formed throughout the display region. Also, the anode electrodes ANODE may be formed as a plurality of stripes in a row direction like the scan lines, as a plurality of stripes in a column direction like the data lines, and/or as a mesh.

Although the anode electrode can be formed as the plurality of stripes or as a mesh, the same voltage Vanode is applied to the anode electrodes ANODE. Electron emission devices of the electron emission display device, each including a cathode electrode, a gate electrode, and an anode electrode, are formed in regions where the scan lines cross the data lines. Here, when one of the scan line and the data line is used as the cathode electrode, the other one of the scan line and the data line is used as the gate electrode.

The data driver 200 applies the data signals corresponding to the input image data to the data lines D1, D2, . . . , and Dm. According to this embodiment of the present invention, a data driver using a pulse width modulation (PWM) method will be described in more detail. However, any suitable data drivers that control the electron emission time of the electron emission devices in response to the input image data can be employed in the present invention.

The scan driver 300 sequentially applies the scan signals to the scan lines S1, S2, . . . , and Sn.

The power source supply unit 400 applies a first power (or voltage) VS1 of a first power source to the data driver 200, applies a second power (or voltage) VS2 of a second power source to the scan driver 300, and applies a third power (or voltage) VS3 of a third power source to the anode electrodes.

The controller 500 obtains the image levels of the image data and then controls (or changes) at least one of the voltages applied to the anode electrodes, the voltages applied to the cathode electrodes, or the voltages applied to the gate electrodes to correspond to the obtained image levels. Here, the image levels correspond to the brightness of the entire display region 100. When the image levels are high, the display region 100 is referred to as being bright. When the image levels are low, the display region 100 is referred to as being dark. For example, the image levels can be obtained by summing the image data of one frame.

The controller 500 controls the power source supply unit 400 to increase the anode voltages during the emission of electrons when the image levels are low and to reduce the anode voltages during the emission of electrons when the image levels are high. When the brightness is realized by controlling the anode voltages, it is possible to prevent the number of gray scales from being reduced and to realize the proper brightness without having to change driving conditions regardless of the driving method being used (e.g., the PWM method or the PAM method).

Also, the controller 500 controls the power source supply unit 400 to increase or decrease a difference in voltage between the cathode electrodes and the gate electrodes. The controller 500 controls the power source supply unit 400 to reduce the difference in voltage between the cathode electrodes and the gate electrodes during the emission of electrons when the image levels are high and to increase the difference in voltage between the cathode electrodes and the gate electrodes during the emission of electrons when image levels are low.

In particular, the controller 500 controls the power supply unit 400 by changing reference voltage Vref. The power source supply unit 400 changes at least one voltage level of the power VS1 or the power VS2 applied to the data driver 200 and the scan driver 300 to correspond to the reference voltage Vref output from the controller 500. Therefore, the voltage levels of the data signals and/or the scan signals output from the data driver 200 and the scan driver 300 are changed so that the difference in voltage between the gate electrodes and the cathode electrodes of the electron emission devices of the display region 100 is changed.

When the data lines operate as the cathode electrodes and the scan lines operate as the gate electrodes, the controller 500 controls the power source supply unit 400 so that the voltages applied by the data driver 200 to the data lines are reduced and/or that the voltages applied by the scan driver 300 to the scan lines are increased when the image levels are low. When the data lines operate as the cathode electrodes and the scan lines operate as the gate electrodes, the controller 500 controls the power source supply unit 400 so that the voltages applied by the data driver 200 to the data lines are increased and/or that the voltages applied by the scan driver 300 to the scan lines are reduced when the image levels are high.

In the electron emission display device, contrast increases when difference in voltage between the cathode electrodes and the gate electrodes increases during the emission of electrons. Power consumption is reduced and the life of the electron emission devices of the display region 100 increases when difference in voltage between the cathode electrodes and the gate electrodes is reduced during the emission of electrons.

FIG. 2 illustrates an example of a part of a display region that can be used for the electron emission display device of FIG. 1. As illustrated in FIG. 2, the display region 100 includes an electron emission substrate 120 and an image forming substrate 130. Also, the display region 100 may further include spacers 140 for maintaining the distance between the electron emission substrate 120 and the image forming substrate 130.

The electron emission substrate 120 that emits electrons corresponding to the voltages between cathode electrodes 122 and gate electrodes 124 includes a bottom surface substrate 121, cathode electrodes 122, one or more insulating layers 123, gate electrodes 124, and electron emission units (or emitters or electron emission sources) 125.

The bottom surface substrate 121 may be formed of glass or silicon. When the electron emission units 125 are formed by exposing the bottom surface substrate 121 using carbon nano tube (CNT) paste, a transparent substrate such as the glass substrate may be used as the bottom surface substrate 121.

The cathode electrodes 122 may be formed as a plurality of stripes on the bottom surface substrate 121. The data signals or the scan signals applied from the data driver or the scan driver are supplied to the cathode electrodes 122. The cathode electrodes 122 may be made of a conductive material. For example, the cathode electrodes may be made of a transparent conductive material, such as indium tin oxide (ITO), like the bottom surface substrate 121.

The insulating layers 123 are formed on the bottom surface substrate 121 and the cathode electrodes 122 to electrically insulate the cathode electrodes 122 and the gate electrodes 124 from each other. The insulating layers 123 are formed of insulating material such as glass obtained by mixing PbO and SiO₂ with each other.

The gate electrodes 124 are formed on the insulating layers 123 in a predetermined shape, for example, in stripes to cross (or cross over) the cathode electrodes 122. The data signals or the scan signals applied from the data driver or the scan driver are supplied to the gate electrodes 124. The gate electrodes 124 may be formed of metal having high conductivity such as Au, Ag, Pt, Al, Cr, or at least one conductive metal selected among the alloys of the above metals. The insulating layers 123 and the gate electrodes 124 include at least one aperture 126 at each of the crossing regions between the cathode electrodes 122 and the gate electrodes 124 so that the cathode electrodes 122 are exposed.

The electron emitting unit 125 is electrically connected to the cathode electrodes 122 exposed by the first apertures 126 and may be formed of carbon nano tube, graphite, diamond, diamond-shaped carbon, nano tube obtained by combining the above, or nano wire formed of Si or SiC.

The electrons emitted from the electron emission substrate 120 collide with the image forming substrate 130 to emit light so that images are formed. The image forming substrate 130 includes a top surface substrate 131, anode electrodes 132, fluorescent bodies 133, light shielding layers 134, and a metal reflecting layer 135.

The top surface substrate 131 may be formed of transparent material such as glass so that the light emitted from the fluorescent bodies 133 is transmitted to the outside.

The anode electrodes 132 may be formed of transparent metal such as ITO so that the light emitted from the fluorescent bodies 133 is transmitted to the outside. The anode electrodes 132 effectively accelerate the electrons emitted from the electron emission devices. Therefore, high positive (+) voltages are applied to the anode electrodes 132 to accelerate the electrons in the direction of the fluorescent bodies 133.

The fluorescent bodies 133 collide with the electrons emitted from the electron emission substrate 120 to emit light and are selectively arranged on the anode electrodes 132 by a predetermined distance. ZnS:Cu, Zn₂SiO₄:Mn, ZnS:Cu+Zn₂SiO₄:Mn, Gd₂O₂S:Tb, Y₃Al₅O₁₂:Ce, ZnS:Cu,Al, Y₂O₂S:Tb, ZnO:Zn, ZnS:Cu,Al+In₂O₃, LaPO₄:Ce,Tb,BaO.6Al₂O₃:Mn, (Zn,Cd)S:Ag, (Zn, Cd)S:Cu,Al,ZnS:Cu,Au,Al, Y₃(Al,Ga)₂O₁₂:Tb, Y₂SiO₅:Tb, or LaOCl:Tb may be used as the G fluorescent body that emits green light. ZnS:Ag, ZnS:Ag,Al, ZnS:Ag,Ga,Al, ZnS:Ag,Cu,Ga,Cl, ZnS:Ag+In₂O₃, Ca₂B₅O₉Cl:Eu²⁺, (Sr,Ca,Ba,Mg)₁₀(PO₄)₆Cl₂:Eu²⁺, Sr₁₀(PO₄)₆C₂:Eu²⁺, BaMgAl₁₆O₂₆:Eu²⁺, ZnS:Ag to which CoO,Al₂O₃ is added, ZnS:Ag or Ga may be used as the B fluorescent body that emits blue light. Y₂O₂S:Eu, Zn₃(PO₄)₂:Mn, Y₂O₃:Eu, YVO₄:Eu, (Y, Gd)BO₃:Eu, γ-Zn₃(PO₄)₂:Mn, (ZnCd)S:Ag, (ZnCd)S:Ag+In₂O₃, or Y₂O₂S:Eu to which Fe₂O₃ is added may be used as the R fluorescent body that emits red light.

The light shielding layers 134 that absorb and intercept external light and that prevent optical cross talk to improve contrast are arranged between the fluorescent bodies 133 and are at a predetermined distance from each other.

The metal reflecting layer 135 is formed on the fluorescent bodies 133 to effectively collect the electrons emitted from the electron emission substrate 120 and to reflect the light emitted from the fluorescent bodies 133 due to the collision of the electrodes to the top surface substrate 131 so that reflection effect is improved. On the other hand, if the metal reflecting layer 135 operates as the anode electrodes 132, it is not necessary to form the anode electrodes 132.

FIG. 3 illustrates an example of the controller 500 that can be used for the electron emission display device of FIG. 1. As illustrated in FIG. 3, the controller 500 includes a frame memory 501, a look-up table (LUT) 502, and an operating unit 503.

The frame memory 501 stores input image signals and outputs data corresponding to one frame.

The LUT 502 stores the average value of the reference brightness levels of image signal data and data conversion indexes of the levels into which the brightness of a screen is divided in accordance with the average value. The LUT 502 does not have to be separately provided and may be realized as a part of the logic in the operating unit 503.

The operating unit 503 determines image levels using the image data of the corresponding one frame. The image levels have larger values as the number of data corresponding to high gray scales increases in the image data of the corresponding one frame. The image levels have smaller values as the number of data corresponding to low gray scales increases in the image data of the corresponding one frame.

For example, the operating unit 503 obtains the image levels using the value obtained by summing the image data corresponding to the one frame stored in the frame memory 501. To be specific, the operating unit 503 obtains the sum of the image data corresponding to the one frame, determines the upper eight bits of the obtained sum as the image levels, and then outputs the determined image levels.

The average value calculated with respect to the obtained predetermined frame and the average value of the reference brightness levels stored in the LUT 502 are compared with each other. In order to control the voltages corresponding to the brightness levels of the predetermined frame, one of the voltages applied to the anode electrodes, the voltages applied to the cathode electrodes, or the voltages applied to the gate electrodes is selected and then is controlled.

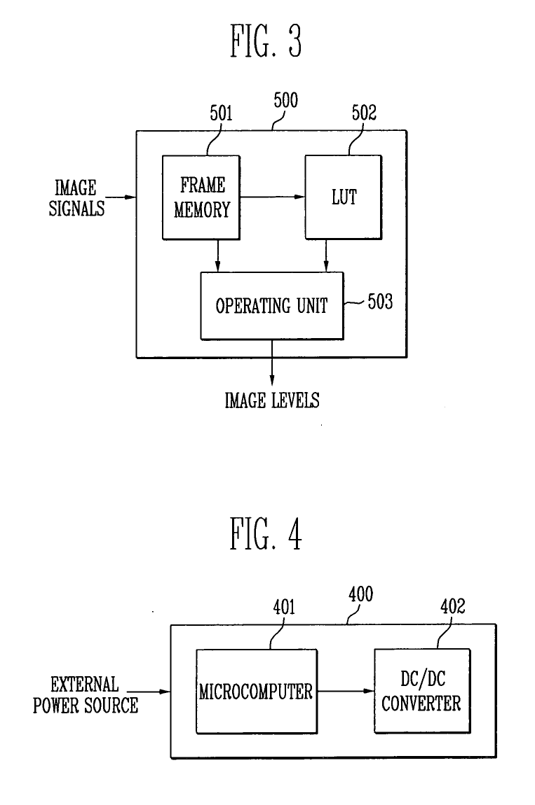

FIG. 4 schematically illustrates the structure of the power source supply unit 400 of FIG. 1. As illustrated in FIG. 4, the power source supply unit 400 includes a microcomputer 401 and a DC/DC converter 402.

The microcomputer 401 receives the image levels controlled by the controller 500 to output the voltage levels corresponding to the image levels. That is, the microcomputer 401 generates reference voltage Vref corresponding to the image levels.

To be specific, when the image levels output from the controller 500 are for controlling the anode voltage levels, the microcomputer 401 reduces the anode voltages when the image levels are high and increases the anode voltages when the image levels are low.

Also, when the image levels output from the controller 500 are for controlling the cathode voltage levels or the gate voltage levels, the microcomputer 401 reduces the voltages of the cathode or gate electrodes when the image levels are high and increases the voltages of the gate electrodes when the image levels are low.

The DC/DC converter 402 converts the widths of the anode voltage levels of the microcomputer 401 to output the signal widths (e.g., the pulse widths).

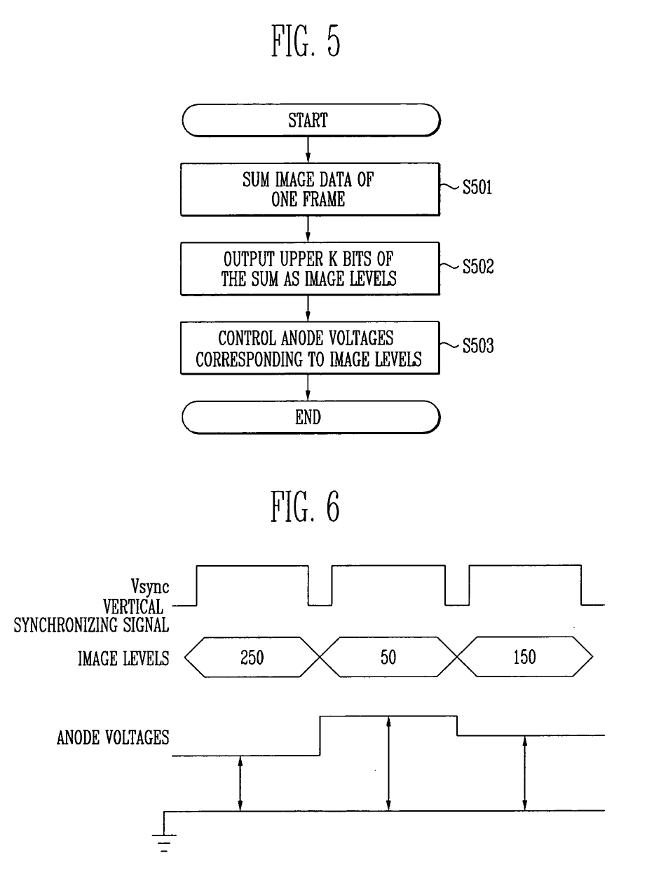

FIG. 5 is a flowchart illustrating a method of controlling brightness of an electron emission display device in an exemplary embodiment according to the present invention. As illustrated in FIG. 5, the input image signals in units of frames is summed at S501. At this time, the operating unit 503 obtains the sum of the image data corresponding to one frame stored in the frame memory 501.

Then, in S502, the upper eight bits of the sum of the image data are determined as image levels to be output. That is, the image levels are determined by upper k (predetermined) bits of the sum of the image data to be output (k is an integer not less than 2).

Then, in S503, the image levels and the predetermined value are compared with each other to control the anode voltages corresponding to the images levels and to apply the anode voltages.

To be specific, the calculated average value of the obtained predetermined frame and the average value of the reference brightness levels stored in the LUT 502 are compared with each other. At this time, the voltages applied to the anode electrodes are controlled to correspond to the brightness levels of the predetermined frame. That is, the anode voltages are reduced when the image levels are high and are increased when the image levels are low.

In addition, after determining the image levels to output the image levels, the voltages between the cathodes and the gates corresponding to the image levels may be further controlled. That is, one of the voltages applied to the cathode electrodes or the voltages applied to the gate electrodes is selected and then is controlled in accordance with the brightness levels of the predetermined frame.

FIG. 6 schematically illustrates anode voltage levels applied in accordance with image levels in an exemplary embodiment according to the present invention. As illustrated in FIG. 6, the anode voltages are reduced when the image levels are large and are increased when the image levels are small to obtain peak brightness. Here, image level signals are output to correspond to a vertical synchronizing signal.

In FIG. 6, when the peak brightness is realized by the anode voltages, it is possible to prevent the number of gray scales from being reduced and to easily control brightness regardless of a driving method such as the PWM method or the PAM method or driving conditions.

In general as described above, in an electron emission display of an embodiment of the present invention and a method of controlling the brightness thereof, image data are added to each other to control anode voltages corresponding to the image data and to thus realize peak brightness.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An electron emission display device comprising:
a controller for summing input image data signals to obtain an image level;
a power source supply unit for receiving the image level to control an anode voltage level to correspond to the image level and to output the anode voltage level; and
a display region for realizing image brightness in accordance with the anode voltage level supplied by the power source supply unit.

2. The electron emission display device as claimed in claim 1, further comprising:
a data driver for applying data signals to the display region; and
a scan driver for applying scan signals to the display region.

3. The electron emission display device as claimed in claim 1, wherein the power source supply unit uses the image level to further control one of a gate voltage level or a cathode voltage level to correspond to the image level and to output the controlled voltage level.

4. The electron emission display device as claimed in claim 3, wherein when the gate voltage level output from the power source supply unit is applied to the data driver, the cathode voltage level is applied to the scan driver; and wherein when the cathode voltage level output from the power source supply unit is applied to the data driver, the gate voltage level is applied to the scan driver.

5. The electron emission display device as claimed in claim 1, wherein the controller comprises:
a frame memory for storing input image data;
an operating unit for summing the image data stored in the frame memory per frame to compare the summed image data with a predetermined value and to determine the image level; and
a look-up table for storing an average value of reference brightness levels in accordance with the image level of the operating unit.

6. The electron emission display device as claimed in claim 1, wherein the power source supply unit comprises:
a microcomputer for receiving the image level controlled by the controller to output a reference voltage level corresponding to the image level; and
a DC/DC converter for converting a width of the reference voltage level of the microcomputer to output a signal width.

7. The electron emission display device as claimed in claim 6, wherein the microcomputer controls the anode voltage level, the cathode voltage level, and the gate voltage level by outputting the reference voltage level.

8. The electron emission display device as claimed in claim 6, wherein the microcomputer reduces the anode voltage when the image level is high and increases the anode voltage when the image level is low.

9. A method of controlling brightness of an electron emission display device, the method comprising:
summing received image data per frame;
determining an image level by the sum of the image data to output the image level; and
comparing the image level with a predetermined value to control an anode voltage and to apply the anode voltage.

10. The method as claimed in claim 9, wherein, in the determining the image level to output the image level, the image level is determined by a predetermined number of upper bits of the sum of the image data.

11. The method as claimed in claim 10, wherein the predetermined number is an integer not less than 2 and the predetermined number of upper bits of the sum of the image data is determined as the image level to be output.

12. The method as claimed in claim 9, wherein, in the controlling the anode voltage to correspond to the image level, the anode voltage is reduced when the image level is high and is increased when the image level is low.

13. The method as claimed in claim 9, wherein, after the determining the image level to output the image level, the method further comprising controlling a voltage between a cathode electrode and a gate electrode to correspond to the image level.

14. A method of controlling brightness of an electron emission display device, the method comprising:
summing received image data;
determining an image level using the summed image data;
outputting the determined image level;
comparing the output image level with a predetermined value to control an anode voltage; and
applying the anode voltage to a display region of the electron emission display device.

15. The method as claimed in claim 14, wherein the image level is determined by a predetermined number of upper bits of the summed image data.

16. The method as claimed in claim 14, wherein the anode voltage is reduced when the image level is high and is increased when the image level is low.

17. The method as claimed in claim 15, further comprising controlling a voltage between a cathode electrode and a gate electrode to correspond to the image level.
